(19) United States
(12) Patent Application Publication
(10) Pub. No.: US 2009/0323968 A1
(43) Pub. Date: Dec. 31, 2009

(54) DESCRAMBLING APPARATUS AND DESCRAMBLING METHOD IN A TV SYSTEM

(76) Inventor: Shih-Ta HSU, Sinshih Township (TW)

Correspondence Address: HAYES SOLOWAY P.C., 3450 E. SUNRISE DRIVE, SUITE 140, TUCSON, AZ, 85718, US

(21) Appl. No.: 12/163,706

(22) Filed: Jun. 27, 2008

(51) Int. Cl. H04L 9/08; H04N 7/167

(52) U.S. Cl. 380/279; 725/31

(57) ABSTRACT

A descrambling apparatus and a descrambling method to descramble a scrambled data in a receiver of a digital TV system are provided. The descrambling apparatus comprises: a receiving module, a storing module, a comparator, a retrieving module and a descrambler. The receiving module receives a packet, wherein the packet comprises a key-status field, a packet identifier field and a scrambled data; the storing module stores a key data and a formerly received packet data; the comparator compares the formerly received packet data and a key-status value of the key-status field to generate a compare result; the retrieving module retrieves a descramble key from the key data and the formerly received packet data according to the compare result, the key-status value and a packet identifier value of the packet identifier field; and the descrambler descrambles the scrambled data according to the descramble key to generate a descrambled data.

### BACKGROUND

1. Field of Invention

The present invention relates to a descrambling apparatus and a descrambling method. More particularly, the present invention relates to a descrambling apparatus and a descrambling method to descramble a scrambled data in a receiver of a digital TV system.

2. Description of Related Art

In order to obtain a higher security in the transfer process on a digital TV data stream, different scramble key can be used in turn to encrypt the data stream. If a CPU in the TV system keeps monitoring the scramble key condition in a real time manner, a sudden change of the scramble key will make the CPU unable to change a corresponding descramble key in time and further cause slight interrupts during the displaying of the TV program.

Accordingly, what is needed is a descrambling apparatus and a descrambling method in a TV system to descramble the scrambled packet without causing an interrupt in the TV program to overcome the above issues. The present invention addresses such a need.

### SUMMARY

A descrambling apparatus to descramble a scrambled data in a receiver of a digital TV system is provided. The descrambling apparatus comprises: a receiving module, a storing module, a comparator, a retrieving module and a descrambler. The receiving module receives a packet, wherein the packet comprises a key-status field, a packet identifier field and a scrambled data, the scrambled data is scrambled with a scramble key and the key-status field specifies whether the scramble key is changed; the storing module stores a key data and a formerly received packet data; the comparator compares the formerly received packet data and a key-status value of the key-status field to generate a compare result; the retrieving module retrieves a descramble key from the key data and the formerly received packet data according to the compare result, the key-status value and a packet identifier value of the packet identifier field; and the descrambler descrambles the scrambled data according to the descramble key to generate a descrambled data.

Another object of the present invention is to provide a descrambling method to descramble a scrambled data in a receiver of a digital TV system comprising the steps of: receiving a packet, wherein the packet comprises a key-status field, a packet identifier field and a scrambled data, the scrambled data is scrambled with a scramble key and the key-status field specifies whether the scramble key is changed; comparing a formerly received packet data and a key-status value of the key-status field to generate a compare result; retrieving a descramble key from a key data and a formerly received packet data according to the compare result, the key-status value and a packet identifier value of the packet identifier field; and descrambling the scrambled data according to the descramble key to generate a descrambled data.

Yet another object of the present invention is to provide a receiver of a TV system comprising: a reception apparatus, a descrambling apparatus, a post-processing apparatus and a display apparatus. The reception apparatus receives a data stream, wherein the data stream is a series of packets; the descrambling apparatus comprising: a receiving module to receive a packet from the data stream, wherein the packet comprises a key-status field, a packet identifier field and a scrambled data, the scrambled data is scrambled with a scramble key and the key-status field specifies whether the scramble key is changed; a storing module to store a key data and a formerly received packet data; a comparator to compare the formerly received packet data and a key-status value of the key-status field to generate a compare result; a retrieving module to retrieve a descramble key from the key data and the formerly received packet data according to the compare result, the key-status value and a packet identifier value of the packet identifier field; and a descrambler to descramble the scrambled data according to the descramble key to generate a descrambled data; the post-processing apparatus receives a plurality of descrambled data, combine the plurality of descrambled data into a plurality of frames and post-process the plurality of frames; and the display apparatus displays the plurality of frames.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a block diagram of a digital TV system of the first embodiment of the present invention;

FIG. 2 is a block diagram of the descrambling apparatus of the first embodiment of the present invention;

FIG. 3 is a diagram of a packet of the first embodiment of the present invention,

FIGS. 4A and 4B are two diagrams of the key tables of two embodiments of the present invention; and

FIG. 5 is a flow chart of the second embodiment of the present invention.

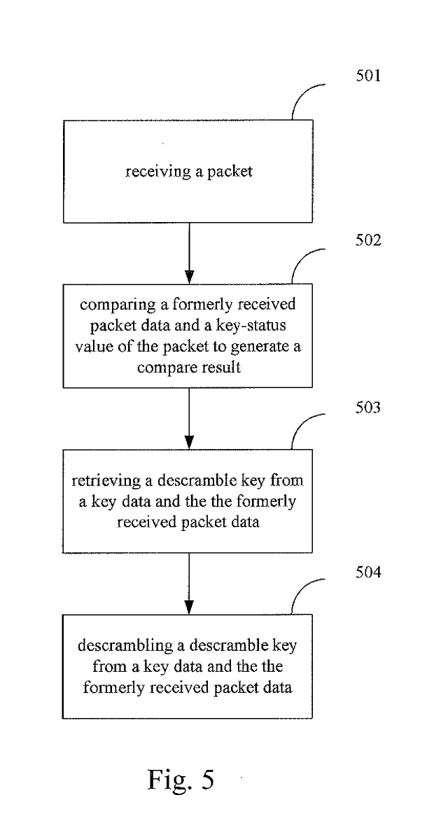

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

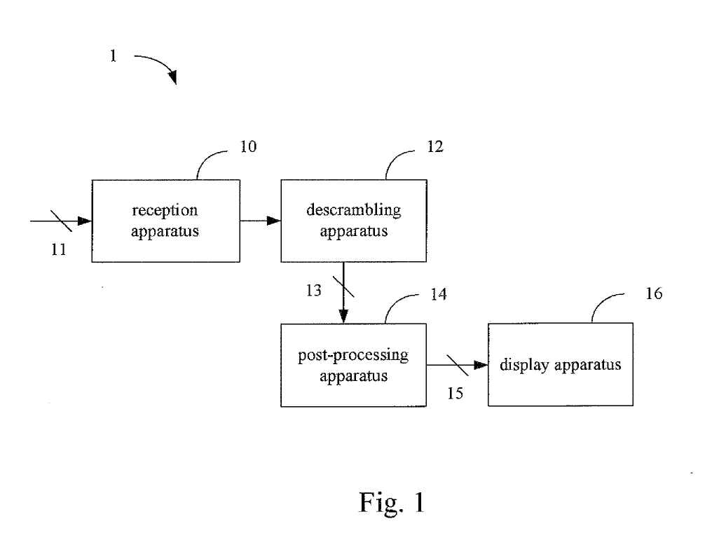

Please refer to FIG. 1, a block diagram of a receiver 1 of a digital TV system (not shown) of the first embodiment of the present invention. The receiver 1 comprises a reception apparatus 10, a descrambling apparatus 12, a post-processing apparatus 14 and a display apparatus 16. The reception apparatus 10 receives a data stream 11, wherein the data stream 11 is a series of packets. The descrambling apparatus 12 descramble a scrambled data of the packets from the data stream 11 and generates a plurality of descrambled data 13. Then the post-processing apparatus 14 receives the plurality of descrambled data 13 and combine the plurality of descrambled data 13 into a plurality of frames. The post-processing apparatus 14 further post-processes the plurality of frames, wherein the post-processing apparatus 14 may comprises mpeg/H.264 decoder and some adjusting module to adjust the size, resolution of each of the frames to produce a plurality of post-processed frames 15. The display apparatus 16 displays the plurality of frames 15.

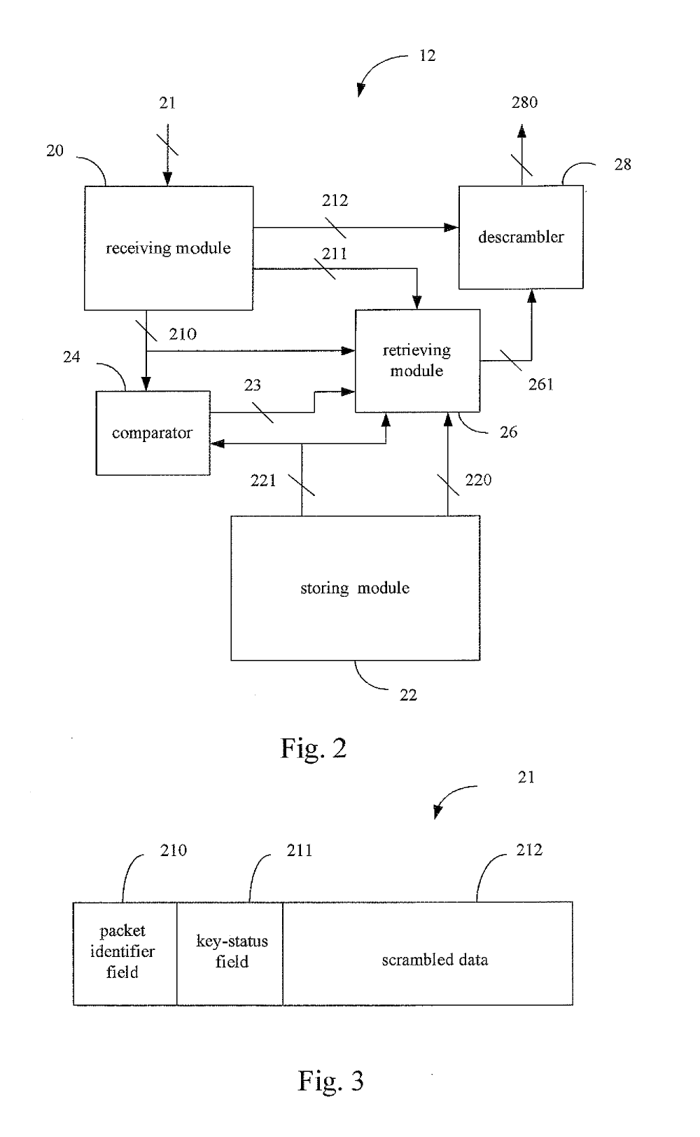

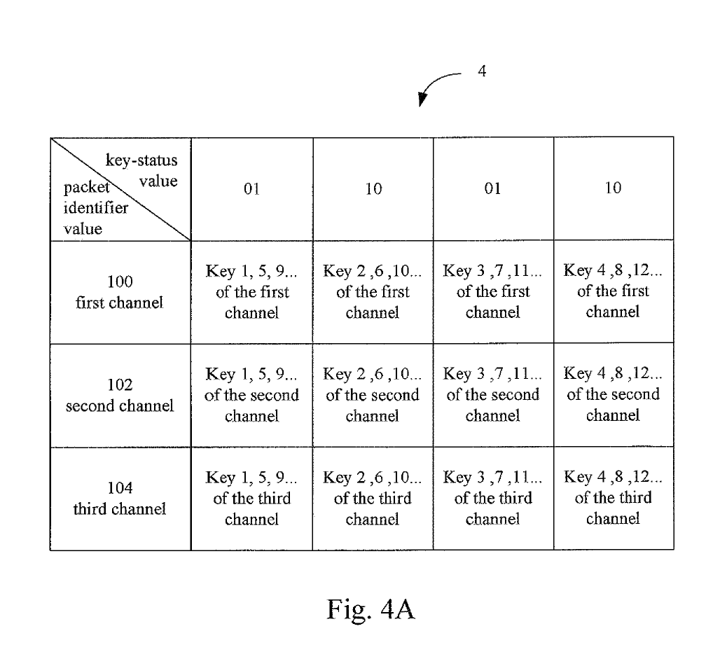

FIG. 2 is a further block diagram of the descrambling apparatus 12 of the first embodiment of the present invention. The descrambling apparatus 12 comprises: a receiving module 20, a storing module 22, a comparator 24, a retrieving module 26 and a descrambler 28. The receiving module 20 receives a packet 21 from the data stream 11, wherein the packet 21 comprises a key-status field 210, a packet identifier field 211 and a scrambled data 212, as depicted in FIG. 3. The scrambled data 212 is scrambled with a scramble key in a sender part of the digital TV system (not shown) and the key-status field 210 specifies whether the scramble key is changed. The storing module 22 stores a key data 220 and a formerly received packet data 221, wherein the formerly received packet data 221 comprises a former key used to descramble the formerly received packet and a former key-status value. The comparator 24 compares the former key-status value of the formerly received packet data 221 and a key-status value of the key-status field 210 to generate a compare result 23. When the compare result 23 is unequal, the retrieving module 26 determines that the scramble key changes in the source of the packets and retrieves a descramble key 261 from the key data 220 to obtain a new descramble key different from the former one. When the compare result 23 is equal, the retrieving module 26 determines that the scramble key doesn't change in the source of the packets and continue to use the former key stored in the key data 220 of the storing module 22 as the descramble key. After retrieving the descramble key, the descrambler 28 descrambles the scrambled data 212 according to the descramble key 261 to generate a descrambled data 280.

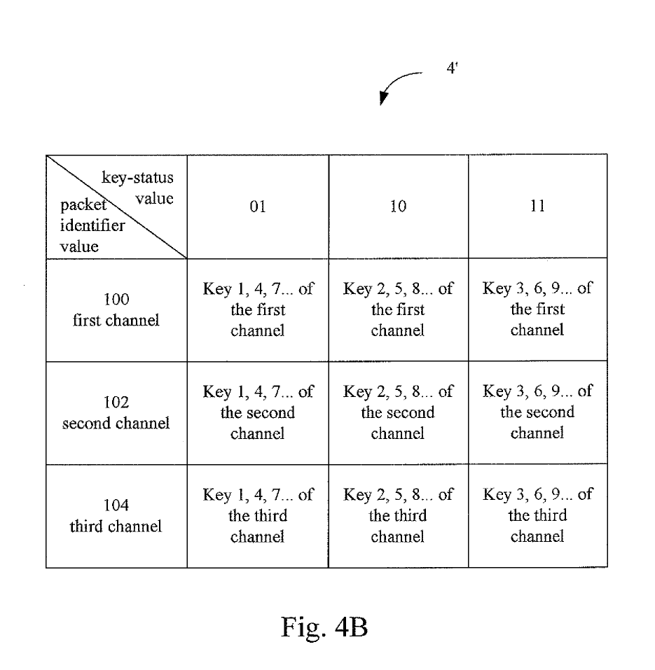

In the present embodiment, the key data 220 is a key table 4 as depicted in FIG. 4A. The key table 4 stores a plurality of keys corresponding to the scramble keys from the source of the packets. The packet identifier value of the packet identifier field 211 and the key-status value are used as the indexes to access the key table. Generally, the key-status value is set as an “odd” status and an “even” status. In FIG. 4A, the odd status is 01 and the even status is 10. When the key-status value is different from the former key-status value, as described previously, the retrieving module 26 determines that the scramble key changes and access the key table 4 with the key-status as one of the index. The packet identifier value of the packet identifier field 211 is used to specify a channel that the packet 21 is sent to and is used as another index of the key table 4. For example, the first channel 100 may be a movie channel and the second channel 102 may be a news channel. In the present embodiment, each channel has four keys stored and the four keys are arranged in an interlaced order of the odd and even key-status, wherein the new keys are stored and used in the order described above. These keys in the key table 4 are updated every specific time period. The more keys are stored, the key table 4 can update with less frequency, i.e. longer time period. In another embodiment, the key status can be specified by more different key-status values as depicted in FIG. 4B. In FIG. 4B, the key table 4′ has three different key-status 01, 10 and 11.

A second embodiment of the present invention is a descrambling method, wherein the descrambling method comprises the steps of: In step 501, receiving a packet, wherein the packet comprises a key-status field, a packet identifier field and a scrambled data; in step 502, comparing a formerly received packet data and a key-status value of the key-status field to generate a compare result; then in step 503, retrieving a descramble key from a key data and a formerly received packet data according to the compare result, the key-status value and a packet identifier value of the packet identifier field; and in step 504, descrambling the scrambled data according to the descramble key to generate a descrambled data.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A descrambling apparatus to descramble a scrambled data in a receiver of a digital TV system comprising:
a receiving module to receive a packet, wherein the packet comprises a key-status field, a packet identifier field and the scrambled data, the scrambled data is scrambled with a scramble key and the key-status field specifies whether the scramble key is changed;
a storing module to store a key data and a formerly received packet data;
a comparator to compare the formerly received packet data and a key-status value of the key-status field to generate a compare result;
a retrieving module to retrieve a descramble key from the key data and the formerly received packet data according to the compare result, the key-status value and a packet identifier value of the packet identifier field; and
a descrambler to descramble the scrambled data according to the descramble key to generate a descrambled data.

2. The descrambling apparatus of claim 1, wherein the formerly received packet data comprises a former key used to descramble the formerly received packet and a former key-status value; the comparator compare the key-status value and the former key-status value to generate the compare result.

3. The descrambling apparatus of claim 2, wherein the key data is a key table

4. The descrambling apparatus of claim 3, when the compare result is unequal, the retrieving module retrieves a key from the key table as the descramble key by using the packet identifier value and the key-status value as the indexes to access the key table.

5. The descrambling apparatus of claim 3, when the compare result is equal, the retrieving module retrieves the former key as the descramble key.

6. The descrambling apparatus of claim 3, wherein the key table is updated every specific time period.

7. The descrambling apparatus of claim 1, wherein the packet identifier value specifies a channel that the packet is sent to.

8. A descrambling method to descramble a scrambled data in a receiver of a digital TV system comprising the steps of:
receiving a packet, wherein the packet comprises a key-status field, a packet identifier field and the scrambled data, the scrambled data is scrambled with a scramble key and the key-status field specifies whether the scramble key is changed;
comparing a formerly received packet data and a key-status value of the key-status field to generate a compare result;
retrieving a descramble key from a key data and a formerly received packet data according to the compare result, the key-status value and a packet identifier value of the packet identifier field; and
descrambling the scrambled data according to the descramble key to generate a descrambled data.

9. The descrambling method of claim 8, wherein the formerly received packet data comprises a former key used to descramble the formerly received packet and a former key-status value; the comparing steps compares the key-status value and the former key-status value to generate the compare result.

10. The descrambling method of claim 9, wherein the key data is a key table.

11. The descrambling method of claim 10, when the compare result is unequal, the retrieving step retrieves a key from the key table as the descramble key by using the packet identifier value and the key-status value as the indexes to access the key table.

12. The descrambling method of claim 10, when the compare result is equal, the retrieving step retrieves the former key as the descramble key.

13. The descrambling method of claim 10, wherein the key table is updated every specific time period.

14. The descrambling method of claim 8, wherein the value of the packet identifier field specifies the channel that the packet is sent to.

15. A receiver of a digital TV system comprising:
a reception apparatus to receive a data stream, wherein the data stream is a series of packets;
a descrambling apparatus comprising:
a receiving module to receive a packet from the data stream, wherein the packet comprises a key-status field, a packet identifier field and a scrambled data, the scrambled data is scrambled with a scramble key and the key-status field specifies whether the scramble key is changed;
a storing module to store a key data and a formerly received packet data;
a comparator to compare the formerly received packet data and a key-status value of the key-status field to generate a compare result;
a retrieving module to retrieve a descramble key from the key data and the formerly received packet data according to the compare result, the key-status value and a packet identifier value of the packet identifier field; and
a descrambler to descramble the scrambled data according to the descramble key to generate a descrambled data;
a post-processing apparatus to receive a plurality of descrambled data, combine the plurality of descrambled data into a plurality of frames and post-process the plurality of frames; and
a display apparatus to display the plurality of frames.

16. The receiver of the digital TV system of claim 15, wherein the formerly received packet data comprises a former key used to descramble the formerly received packet and a former key-status value; the comparator compare the key-status value and the former key-status value to generate the compare result.

17. The receiver of the digital TV system of claim 16, wherein the key data is a key table.

18. The receiver of the digital TV system of claim 17, when the compare result is unequal, the retrieving module retrieves a key from the key table as the descramble key by using the packet identifier value and the key-status value as the indexes to access the key table.

19. The receiver of the digital TV system of claim 17, when the compare result is equal, the retrieving module retrieves the former key as the descramble key.

20. The receiver of the digital TV system of claim 17, wherein the key table is updated every specific time period.
